(19) United States
(12) Patent Application Publication
(10) Pub. No.: US 2011/0201485 A1
(43) Pub. Date: Aug. 18, 2011

(54) BIAS CHARGE ROLLER COMPRISING OVERCOAT LAYER

(75) Inventors: Brian P. Gilmartin, Williamsville, NY (US); Liang-Bih Lin, Rochester, NY (US); Jeanne M. Koval, Marion, NY (US); Aaron M. Stuckey, Fairport, NY (US)

(73) Assignee: Xerox Corporation, Norwalk, CT (US)

(21) Appl. No.: 12/706,977

(22) Filed: Feb. 17, 2010

(51) Int. Cl. B05C 1/08; G03G 15/02

(52) U.S. Cl. 492/18; 399/176

(57) ABSTRACT

Disclosed are overcoat layers comprising an acrylic resin crosslinked with a glycoluril resin. The overcoat layers are useful in bias charge rollers because they reduce streaking and increase service lifetime.

### BACKGROUND

The present disclosure relates to overcoat layers useful in bias charge rollers, imaging apparatuses, and the rollers and apparatuses themselves. Among other advantages, the overcoat layers improve the lifetimes of the rollers and apparatuses while limiting streaking.

Electrostatographic and xerographic reproductions may be initiated by depositing a uniform charge on an imaging member, i.e. photoreceptor, followed by exposing the imaging member to a light image of an original document. Exposing the charged imaging member to a light image causes discharge in areas corresponding to non-image areas of the original document while the charge is maintained on image areas, creating an electrostatic latent image of the original document on the imaging member. The latent image is subsequently developed into a visible image by depositing a charged developing material, i.e. toner, onto the photoconductive surface layer, such that the developing material is attracted to the charged image areas on the imaging member. Thereafter, the developing material is transferred from the imaging member to a copy sheet or some other image support substrate to which the image may be permanently affixed for producing a reproduction of the original document. In a final step in the process, the imaging member is cleaned to remove any residual developing material therefrom, in preparation for subsequent imaging cycles.

Various devices and apparatuses have been used to create a uniform electrostatic charge or charge potential on the photoconductive surface of an imaging member before forming the latent image thereon. Charging of the imaging member may be broken down into two types: noncontact and contact charging. Traditionally, noncontact charging has been used. In this method, corona generating devices are utilized to apply a charge to the imaging member. In a typical corona generating device, a suspended electrode, or coronode, comprising a thin conductive wire is partially surrounded by a conductive shield. The device is placed in close proximity to the photoconductive surface of the imaging member. The coronode is electrically biased to a high voltage potential, causing ionization of surrounding air which results in the deposit of an electrical charge on an adjacent surface, namely the photoconductive surface of the imaging member.

Several problems have historically been associated with corona generating devices. Problems include the use of very high voltages, i.e. from 3,000 to 8,000 V, requiring the use of special insulation, inordinate maintenance of corotron wires, low charging efficiency, the need for erase lamps and lamp shields, arcing caused by non-uniformities between the coronode and the surface being charged, vibration and sagging of corona generating wires, contamination of corona wires, and, in general, inconsistent charging performance due to the effects of humidity and airborne chemical contaminants on the corona generating device.

Perhaps the most significant problem with corona generating devices is the generation of ozone and nitrogen oxides. Corona charging ionizes the air between the charging device and the imaging member and some diatomic oxygen (O₂) is inevitably converted to ozone (O₃). Ozone poses well-documented health and environmental hazards. Nitrogen oxides oxidize various machine components, adversely affecting the quality of the final output print produced.

A bias charge roller is a contact charger that has been developed and overcomes some of the deficiencies of corona generating devices. When used to charge an imaging member, a roller used to create a charge on another surface or substrate is commonly referred to as a bias charge roller. When used to charge an intermediate transfer member that transfers a developed image from an imaging member to a substrate member, this roller is sometimes called a bias transfer roll. Although both may differ in minor details particular to their applications, a bias transfer roll should also be considered a bias charge roller for purposes of this application.

Imaging apparatuses comprising bias charge rollers have a power supply for providing a voltage to the bias charge roller. The power supply may be a part of the bias charge roller or may be a separate component.

Bias charge rollers require their outer layer to have a resistivity within a desired range. Materials with resistivities which are too low will cause shorting and/or unacceptably high current flow to the imaging member. Materials with too high resistivities will require unacceptably high voltages. Other problems which can result if the resistivity is not within the required range include nonconformance at the contact nip and poor toner releasing properties. These adverse effects can also result in the bias charge roller having non-uniform resistivity across the length of the contact member. Other problems include resistivity that is susceptible to changes in temperature, relative humidity, and running time.

Bias charge rollers also cause wear and tear to imaging members because they physically contact the imaging member. One of the more common problems is the appearance of streaks along the process direction, i.e. the circumference, or white and dark spots associated with surface damage. These streaks may result in print defects that can shorten the lifetime of the bias charge roller, the imaging member, and the ink or toner cartridge. Streaking usually develops as a result of the degradation of the bias charge roller material and/or the buildup of debris along the process direction of the roller. Defects include scratches, abrasions, potholes, and the like.

It would be desirable to develop a bias charge roller that reduces streaking and has an increased service lifetime.

### BRIEF DESCRIPTION

The present application discloses, in various embodiments, bias charge rollers having an overcoat layer comprising an acrylic resin crosslinked with a glycoluril resin. Imaging apparatuses comprising the bias charge rollers are also disclosed. The overcoat layers reduce streaking and increase the service lifetime of the bias charge rollers.

In embodiments, a bias charge roller is disclosed which comprises a conductive core and an overcoat layer. The overcoat layer comprises an acrylic resin crosslinked with a glycoluril resin.

The overcoat layer does not contain conductive particles in some embodiments.

The acrylic resin may comprise from about 50 to about 85 wt % of the overcoat layer. The glycoluril resin may comprise from about 15 to about 50 wt % of the overcoat layer. The overcoat layer may have a thickness of from 1 μm to 15 μm.

The acrylic resin may be derived from an acrylate having the structure of Formula (I):

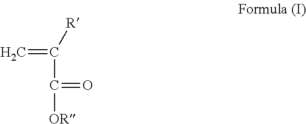

wherein R′ and R″ are independently hydrogen or alkyl.

The glycoluril resin may have the structure of Formula (II):

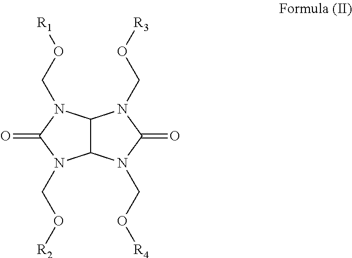

wherein R₁, R₂, R₃, and R₄ are independently H or alkyl having from 1 to about 8 carbon atoms. In particular embodiments, R₁, R₂, R₃, and R₄ are butyl.

In other embodiments is disclosed a bias charge roller comprising an overcoat layer. The overcoat layer is formed from a coating solution comprising: an acrylic resin; a glycoluril resin; and a catalyst.

In embodiments, the coating solution and the overcoat layer do not contain conductive particles.

The catalyst may be selected from the group consisting of oxalic acid, maleic acid, carboxylic acid, ascorbic acid, malonic acid, succinic acid, tartaric acid, citric acid, p-toluenesulfonic acid, methanesulfonic acid, and mixtures thereof.

An image forming apparatus for forming images on a recording medium is also disclosed. The image forming apparatus comprises an electrophotographic imaging member having a charge-retentive surface to receive an electrostatic latent image thereon, a development component to apply a developer material to the charge-retentive surface and form a developed image on the charge-retentive surface, a transfer component for transferring the developed image from the charge-retentive surface to another member or a copy substrate, a fusing member to fuse the developed image to the copy substrate, and a bias charge roller for applying a charge to the charge-retentive surface. The electrophotographic imaging member comprises a substrate, an electrically conductive layer when the substrate is not electrically conductive, a charge generating layer, and a charge transport layer. The bias charge roller comprises an overcoat layer comprised of an acrylic resin crosslinked with a glycoluril resin.

These and other non-limiting characteristics of the disclosure are more particularly disclosed below.

### BRIEF DESCRIPTION OF THE DRAWINGS

The following is a brief description of the drawings, which are presented for the purposes of illustrating the exemplary embodiments disclosed herein and not for the purposes of limiting the same.

FIG. 1 illustrates an exemplary embodiment of a bias charge roller fabricated according to the present disclosure.

FIG. 2 is a top view of an exemplary embodiment of a bias charge roller illustrating the process direction.

FIG. 3 illustrates an exemplary image forming apparatus of the present disclosure.

FIG. 4 is a graph showing the charge uniformity testing of a conventional bias charge roller lacking an overcoat layer.

FIG. 5 is a graph showing the charge uniformity testing of a bias charge roller fabricated with an overcoat layer.

FIG. 6 illustrates a print image from a control imaging apparatus after 50,000 cycles wherein the bias charge roller does not have an overcoat layer.

FIG. 7 illustrates a print image from an imaging apparatus fabricated with an overcoat layer after 50,000 cycles.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range of “from about 2 to about 10” also discloses the range “from 2 to 10.”

The present disclosure relates to overcoat layers that are useful in bias charge rollers of imaging apparatuses. The overcoat layers comprise an acrylic resin crosslinked with a glycoluril resin. Bias charge rollers containing the overcoat layer are disclosed.

The present disclosure also relates to an apparatus for applying an electrical charge to a member to be charged. The apparatus comprises a power supply for supplying a voltage and a bias charge roller situated in proximity to a surface of the member to be charged. The bias charge roller comprises an overcoat layer comprised of an acrylic resin crosslinked with a glycoluril resin.

Also disclosed is an image forming apparatus for forming images on a recording medium. The image forming apparatus comprises an electrophotographic imaging member having a charge-retentive surface to receive an electrostatic latent image thereon, a development component to apply a developer material to the charge-retentive surface to develop the electrostatic latent image to form a developed image on the charge-retentive surface, a transfer component for transferring the developed image from the charge-retentive surface to another member or a copy substrate, a fusing member to fuse the developed image to the copy substrate, and a bias charge roller for applying a charge to the charge-retentive surface. The electrophotographic imaging member comprises a substrate, an electrically conductive layer when the substrate is not electrically conductive, a charge generating layer, and a charge transport layer. The bias charge roller comprises an overcoat layer comprised of an acrylic resin crosslinked with a glycoluril resin.

The crosslinked overcoat is able to reduce streaking and increase service lifetime without the addition of conductive particles such as carbon black or metal oxides. In some embodiments, the overcoat layer does not contain conductive particles. The crosslinked overcoat may be self-conductive.

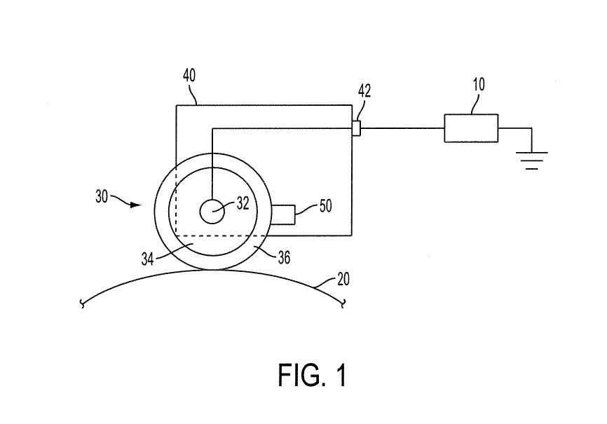

In FIG. 1, a portion of an image forming apparatus is shown. The image forming apparatus has a power supply 10, an imaging member surface 20, and a bias charge roller 30. One of ordinary skill in the art understands that there may be additional components in the imaging apparatus. The imaging member may be a drum, a belt, a film, a drelt, or any other type of imaging member. The bias charge roller 30 comprises a conductive core and an overcoat layer 36. As shown here, the conductive core is formed from a core 32 and a conductive layer 34.

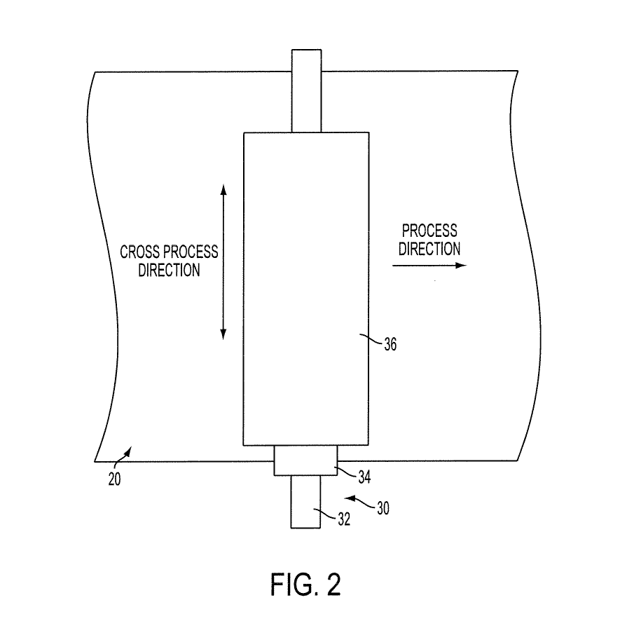

FIG. 2 is a diagram illustrating the operation of the bias charge roller. The bias charge roller rotates about the axis of the core, either under its own power or by friction with the imaging member surface. The direction in which the imaging member surface travels is considered the process direction, and corresponds roughly to a radial direction of the bias charge roller itself, or perpendicular to the axis of the core.

The overcoat layer for the bias charge roller should have a surface resistivity of from 10⁵ to 10¹³ ohm/sq in order to achieve good print quality. The overcoat layer should adhere well to the conductive layer. The overcoat layer of the bias charge roller is formed by the crosslinking of an acrylic resin with a glycoluril resin. The term “acrylic resin” refers to a polymer formed by the polymerization of an acrylate monomer. Generally, the acrylate monomer used to form the acrylic resin has the structure of Formula (I):

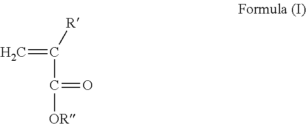

wherein R′ and R″ are independently hydrogen or alkyl. Specific acrylate monomers include acrylic acid, methacrylic acid, ethyl acrylate, or methyl methacrylate. The acrylic resin may also contain repeating units derived from other monomers, i.e. the acrylic resin is a copolymer. In other specific embodiments, the acrylic resin is a homopolymer.

The acrylic resin may have an average molecular weight (M_{w}) of from about 100,000 to about 500,000, including from about 120,000 to about 200,000. The acrylic resin may also have a polydispersity index (M_{W}/Mₙ) of from about 1.5 to about 4, including from about 2 to about 3. The bulk resistivity of the acrylic resin (at 20° C. and 50% humidity) may be from about 10⁸ to about 10¹⁴Ω·cm or from about 10⁹ to about 10¹²Ω·cm.

Particularly suitable acrylic resins for this application include DORESCO® TA22-8 (commercially available from Lubrizol Dock Resins of Linden, N.J.) which is a self-crosslinking thermoset acrylic resin and is believed to possess an M_{w} of about 160,000, a polydispersity index of about 2.3, and a bulk resistivity of about 10¹¹Ω·cm.

The acrylic resin may be present in an amount of about 50 to about 85 wt % in the overcoat layer. In particular embodiments, the acrylic resin comprises about 65 wt % of the overcoat layer.

The glycoluril resin may be represented by the structure of Formula (II):

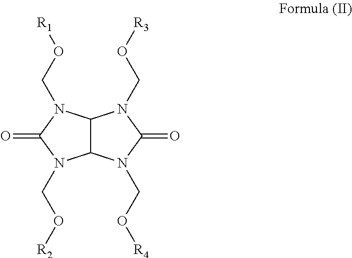

wherein R₁, R₂, R₃, and R₄ are independently H or alkyl having from 1 to about 8 carbon atoms, including from 1 to about 4 carbon atoms. In some embodiments, R₁-R₄ are the same. In more specific embodiments, R₁-R₄ are butyl. Such resins are commercially available under various trade names, including CYMEL® and POWDERLlNK™. In particular embodiments, the glycoluril resin is CYMEL® 1170 or 1171 available from CYTEC Industries, Inc.

The glycoluril resin may be present in an amount of from about 15 to about 50 wt % in the overcoat layer. In a particular embodiment, the glycoluril resin comprises about 35 wt % of the overcoat layer.

The amount of crosslinking may be from about 50 to about 99% or from about 50 to about 80%.

A catalyst may be added to increase the crosslinking rate of the resins. In particular embodiments, the catalyst is an acid, such as oxalic acid, maleic acid, carboxylic acid, ascorbic acid, malonic acid, succinic acid, tartaric acid, citric acid, p-toluenesulfonic acid, methanesulfonic acid, or mixtures thereof. When a catalyst is used, the amount of crosslinking of the resin may approach 100%. The residue of the catalyst may also be present in the overcoat layer, generally in very small amounts.

A low surface energy additive may also be included in the overcoat layer. Examples of low surface energy additives are hydroxyl-containing perfluoropolyoxyalkanes such as FLUOROLINK® D (M.W. of about 1,000 and fluorine content of about 62 percent), FLUOROLINK® D10-H (M.W. of about 700 and fluorine content of about 61 percent), and FLUOROLINK® D10 (M.W. of about 500 and fluorine content of about 60 percent) (—CH₂OH); FLUOROLINK® E (M.W. of about 1,000 and fluorine content of about 58 percent) and FLUOROLINK® E10 (M.W. of about 500 and fluorine content of about 56 percent) (—CH₂(OCH₂CH)ₙOH); FLUOROLINK® T (M.W. of about 550 and fluorine content of about 58 percent), and FLUOROLINK® T10 (M.W. of about 330 and fluorine content of about 55 percent) (—CH₂OCH₂CH(OH)CH₂OH); hydroxyl-containing perfluoroalkanes (R_{f}CH₂CH₂OH, wherein R_{f}═F(CF₂CF₂)ₙ) such as ZONYL® BA (M.W. of about 460 and fluorine content of about 71 percent), ZONYL® BA-L (M.W. of about 440 and fluorine content of about 70 percent), ZONYL® BA-LD (M.W. of about 420 and fluorine content of about 70 percent), and ZONYL® BA-N (M.W. of about 530 and fluorine content of about 71 percent); carboxylic acid-containing fluoropolyethers such as FLUOROLINK® C (M.W. of about 1,000 and fluorine content of about 61 percent); carboxylic ester-containing fluoropolyethers such as FLUOROLINK® L (M.W. of about 1,000 and fluorine content of about 60 percent) and FLUOROLINK® L10 (M.W. of about 500 and fluorine content of about 58 percent); carboxylic ester-containing perfluoroalkanes (RfCH₂CH₂O(C═O)R, wherein R_{f}═F(CF₂CF₂)ₙ and R is alkyl) such as ZONYL® TA-N (fluoroalkyl acrylate, R═CH₂═CH—, M.W. of about 570 and fluorine content of about 64 percent), ZONYL® TM (fluoroalkyl methacrylate, R═CH₂═C(CH₃)—, M.W. of about 530 and fluorine content of about 60 percent), ZONYL® FTS (fluoroalkyl stearate, R═C₁₇H₃₅, M.W. of about 700 and fluorine content of about 47 percent), ZONYL® TBC (fluoroalkyl citrate, M.W. of about 1,560 and fluorine content of about 63 percent); sulfonic acid-containing perfluoroalkanes (R_{f}CH₂CH₂SO₃H, wherein R_{f}═F(CF₂CF₂)ₙ) such as ZONYL® TBS (M.W. of about 530 and fluorine content of about 62 percent); ethoxysilane-containing fluoropolyethers such as FLUOROLINK® S10 (M.W. of about 1,750 to about 1,950); phosphate-containing fluoropolyethers such as FLUOROLINK® F10 (M.W. of about 2,400 to about 3,100); hydroxyl-containing silicone modified polyacrylates such as BYK-SILCLEAN® 3700; polyether modified acryl polydimethylsiloxanes such as BYK-SILCLEAN® 3710; and polyether modified hydroxyl polydimethylsiloxanes such as BYK-SILCLEAN® 3720. FLUOROLINK® is a trademark of Ausimont, ZONYL® is a trademark of DuPont, and BYK-SILCLEAN® is a trademark of BYK.

The low surface energy additive may be present in an amount of from about 0.1 to about 10 wt % in the overcoat layer. In particular embodiments, the low surface energy component comprises about 2 wt % of the overcoat layer.

The overcoat layer may have a thickness of from about 0.1 μm to about 500 μm, or from about 1 μm to about 50 μm. In particular embodiments, the overcoat layer has a thickness of from about 1 μm to about 15 μm, including about 5 μm.

The overcoat layer may be applied by any suitable conventional technique such as spraying, dip coating, draw bar coating, gravure coating, silk screening, air knife coating, reverse roll coating, vacuum deposition, chemical treatment and the like. In embodiments, the overcoat layer is applied in the form of a coating solution comprising the acrylic resin, the glycoluril resin, and a catalyst. These three ingredients are dispersed or dissolved in a solvent. Suitable solvents include xylene, 1-butanol, methyl ethyl ketone, and the like and mixtures thereof. The coating solution may also include the low surface energy additive. The order in which the ingredients are added to the coating solution is not important. The coating solution can be deposited by conventional techniques such as by vacuum, heating and the like. The solvent is removed after deposition of the coating solution by conventional techniques such as by vacuum, heating and the like. The overcoat layer may be cured or dried at a temperature of from about 40 to about 200° C. for a suitable period of time, such as from about 1 minute to about 10 hours, under stationary conditions or in an air flow.

The core 32 of the bias charge roller is used to support the bias charge roller, and may generally be made up of any conductive material. Exemplary materials include aluminum, iron, copper, or stainless steel. The shape of the core may be cylindrical, tubular, or any other suitable shape. The core may have a length of from 200 mm to 700 mm. The diameter of the core may be from about 1 mm to about 20 cm, or from about 5 mm to about 2 cm.

The conductive layer 34 of the bias charge roller surrounds the core 32. The conductive layer comprises a polymeric material such as, for example, neoprene, EPDM rubber, nitrile rubber, polyurethane rubber (polyester type), polyurethane rubber (polyether type), silicone rubber, VITON/FLUOREL rubber, epichlorohydrin rubber, or other similar materials having a DC volume resistivity in the range of 10³ to 10⁷ ohm-cm after suitable compounding with a conductive filler such as carbon particles, graphite, pyrolytic carbon, metal oxides, ammonium perchlorates or chlorates, alkali metal perchlorates or chlorates, conductive polymers like polyaniline, polypyrrole, polythiophene, and polyacetylene, and the like. The conductive filler may be present in the amount of from about 1 to about 30 parts by weight per 100 parts by weight of the polymeric material. Desirably, the conductive layer is deformable to ensure close proximity or contact with the imaging member surface. The Shore 0 hardness is typically from about 15 to about 80. The elastomer may be, for example, urethane rubber, epichlorohydrin elastomers, EPDM rubbers, styrene butadiene rubbers, fluoro-elastomers, silicone rubbers, or any other suitable material. The conductive layer may have any suitable thickness such as, for example, about 10 mm to about 20 cm, preferably from about 50 mm to about 3 cm. It is also possible to use a stiff, non-conformable conductive layer.

The power supply 10 may connect to the bias charge roller 30 via the core 32. The voltage provided by the power supply may be a standard line voltage or other voltage levels or signal frequencies which may be desirable in accordance with other limiting factors dependent upon the individual machine design. The power supply may provide a DC voltage, an AC voltage, or variations thereof.

In some applications, the bias charge roller may be provided in the form of a cartridge for easy insertion and removal from the image forming apparatus. As seen in FIG. 1, the cartridge 40 contains the bias charge roller 30. A power interface 42 exists to connect the bias charge roller 30 to the power supply 10 of the image forming apparatus and supply voltage to the bias charge roller. A cleaning member 50 may also be present to remove toner, paper dust, lubricant, etc. that is transferred from the imaging member surface 20 to the bias charge roller 30. The cleaning member may be, for example, a felt, sponge, etc., and may be shaped as, for example, a roller, a plate, or a sheet.

The overcoat layer of the present disclosure improves the lifetime of the bias charge roller and has improved print properties over time, i.e. it does not produce dark streaks, and does not need conductive particles. The overcoated bias charge roller also displays excellent charge uniformity. The overcoat layer also allows for refurbishing of a used bias charge roller; after applying the overcoat layer to the damaged surface, the bias charge roller can continue to be used.

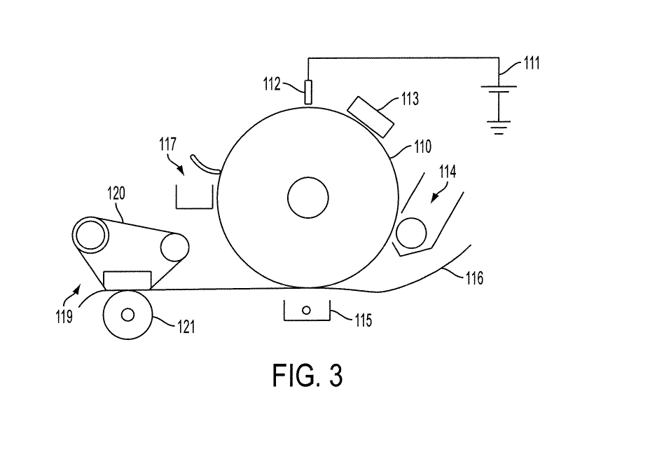

The bias charge roller may be used in an image forming apparatus that forms images on a recording medium, such as that shown in FIG. 3. Such an image forming apparatus comprises an electrophotographic imaging member, a development component, a transfer component, and a fusing member. The electrophotographic imaging member has a charge-retentive surface to receive an electrostatic latent image thereon. The electrophotographic imaging member generally comprises a substrate, an electrically conductive layer when the substrate is not electrically conductive, a charge generating layer, and a charge transport layer. Imaging members are known in the art. The bias charge roller applies a uniform charge to the charge-retentive surface. After the electrostatic latent image is generated, the development component applies a developer material, i.e. toner, to the charge-retentive surface to develop the electrostatic latent image and form a developed image on the charge-retentive surface. The transfer component transfers the developed image from the charge-retentive surface to another member or a copy substrate, such as paper. The fusing member fuses the developed image to the copy substrate.

Referring to FIG. 3, the charge-retentive surface of imaging member 110 is charged by bias charge roller 112 to which a voltage has been supplied from power supply 111. The imaging member is then imagewise exposed to light from an optical system or an image input apparatus 113, such as a laser and light emitting diode, to form an electrostatic latent image thereon. Generally, the electrostatic latent image is developed by bringing a developer mixture from developer station 114 into contact therewith. Development can be effected by use of a magnetic brush, powder cloud, or other known development process. A dry developer mixture usually comprises carrier granules having toner particles adhering triboelectrically thereto. Toner particles are attracted from the carrier granules to the latent image forming a toner powder image thereon. Alternatively, a liquid developer material may be employed, which includes a liquid carrier having toner particles dispersed therein. The liquid developer material is advanced into contact with the electrostatic latent image and the toner particles are deposited thereon. After the toner particles have been deposited on the photoconductive surface, they are transferred to a copy substrate 116 by transfer component 115, which can be pressure transfer or electrostatic transfer. Alternatively, the developed image can be transferred to an intermediate transfer member, or bias transfer member, and subsequently transferred to a copy substrate. Examples of copy substrates include paper, transparency material such as polyester, polycarbonate, or the like, cloth, wood, or any other desired material upon which the finished image will be situated. After the transfer of the developed image is completed, copy substrate 116 advances to fusing member 119, depicted as fuser belt 120 and pressure roll 121, wherein the developed image is fused to copy substrate 116 by passing the copy substrate between the fuser belt and pressure roll, thereby forming a permanent image. Alternatively, transfer and fusing can be effected by a transfix application. The imaging member 110 then advances to cleaning station 117, wherein any remaining toner is cleaned therefrom by use of a blade (as shown in FIG. 1), brush, or other cleaning apparatus.

The present disclosure will further be illustrated in the following non-limiting working examples, it being understood that these examples are intended to be illustrative only and that the disclosure is not intended to be limited to the materials, conditions, process parameters and the like recited herein. All proportions are by weight unless otherwise indicated.

### EXAMPLES

### Comparative Example 1

A bias charge roller without an overcoat layer was used for comparison. The bias charge roller was tested for charge uniformity before being tested (i.e. t=0). The bias charge roller was then cycled 50,000 times in a Hodaka wear rate fixture. The bias charge roller was then tested for charge uniformity (t=50,000). The bias charge roller was also print tested in a copier after the wear testing.

### Example 1

A coating solution was prepared by mixing 65 wt % DORESCO® TA22-8 acrylic resin with 35 wt % CYMEL® 1170 glycoluril resin in methyl ethyl ketone solvent (˜17% total solids). 2% BYK-SILCLEAN® 3700 and 1% p-toluenesulfonic acid were added to the solution (percentages relative to the acrylic and glycoluril resins). A 4 μm overcoat layer was coated on a bias charge roller identical to the one used in Comparative Example 1 using a Tsukiage coater. The bias charge roller was then dried in a convection oven for 15 minutes at 140° C. to remove the solvent and cure the overcoat. The final composition of the overcoat layer was about 63 wt % acrylic resin, about 34 wt % glycoluril resin, about 2 wt % BYK-SILCLEAN® 3700, and about 1 wt % p-toluenesulfonic acid.

The bias charge roller was tested for charge uniformity prior to wear testing (t=0). The bias charge roller was then cycled 50,000 times in a Hodaka wear rate fixture, and subjected to charge uniformity testing using the same procedure (t=50,000). The bias charge roller was also print tested in a copier after the wear testing.

### Charge Uniformity Testing

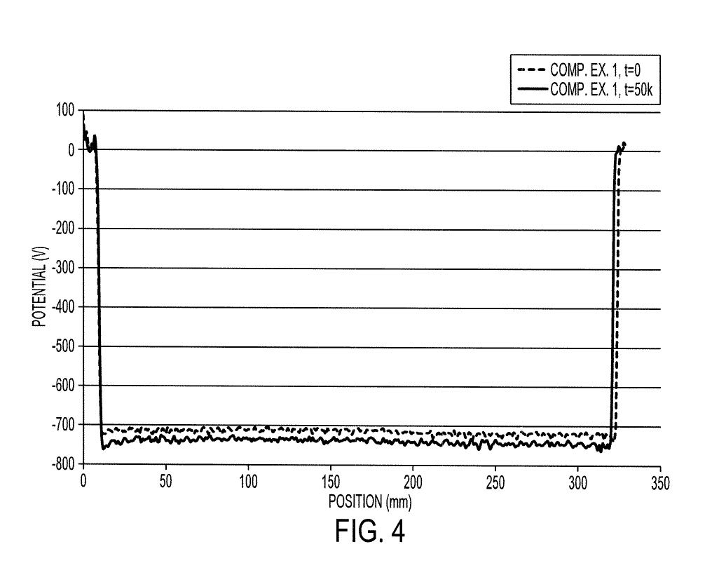

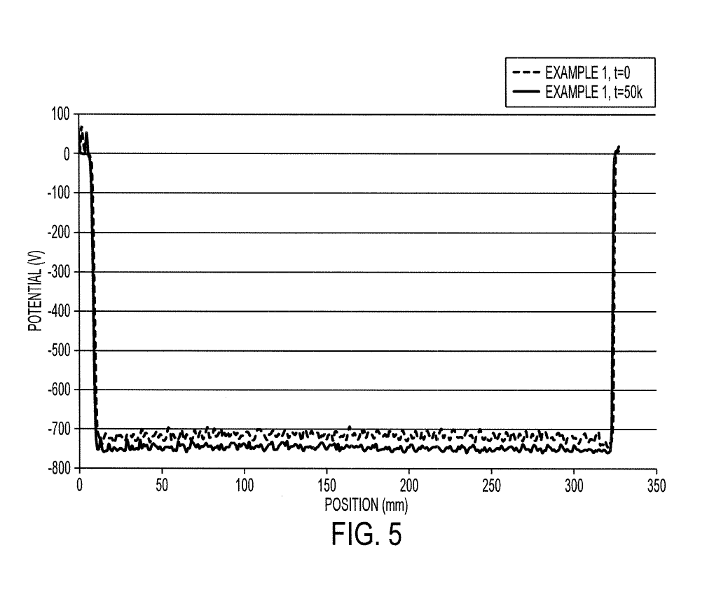

The charge uniformity tests for Comparative Example 1 are shown in FIG. 4, and the charge uniformity tests for Example 1 are shown in FIG. 5. For the x-axis of these graphs, 0 refers to one end of the roller and 328 refers to the other end of the roller. As can be seen in FIG. 4, the potential for Comparative Example 1 is a relatively straight line between the ends of the roller, both before and after the wear testing. Similarly, as seen in FIG. 5, the potential for Example 1 is also a relatively straight line between the ends of the roller, both before and after the wear testing. This indicated that there was no electrical charge build-up in the overcoat layers and no deterioration of charge capacity, i.e. that the addition of the overcoat layer did not affect the relevant electrical properties of the bias charge roller.

### Print Testing

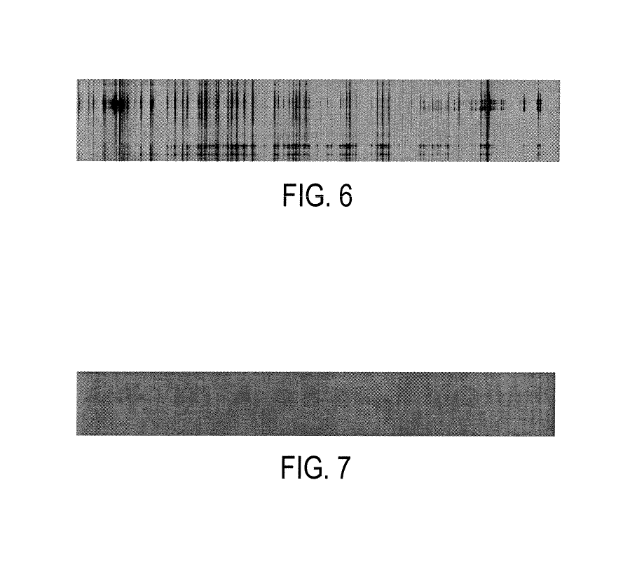

FIG. 6 shows the results of the print testing for the bias charge roller of Comparative Example 1 and FIG. 7 shows the results of the print testing for Example 1. The bias charge roller of Comparative Example 1 showed significant streaking. On the other hand, no print defects were observed in the bias charge roller of Example 1. This indicated that the bias charge roller of Comparative Example 1 sustained significant wear while the overcoat layer improved the wear resistance of the bias charge roller of Example 1.

While particular embodiments have been described, alternatives, modifications, variations, improvements, and substantial equivalents that are or may be presently unforeseen may arise to applicants or other skilled in the art. Accordingly, the appended claims as filed and as they are amended are intended to embrace all such alternatives, modifications, variations, improvements, and substantial equivalents.

What is claimed is:

1. A bias charge roller comprising a conductive core and an overcoat layer, wherein the overcoat layer comprises an acrylic resin crosslinked with a glycoluril resin.

2. The bias charge roller of claim 1, wherein the overcoat layer does not contain conductive particles.

3. The bias charge roller of claim 1, wherein the acrylic resin comprises from about 50 to about 85 wt % of the overcoat layer.

4. The bias charge roller of claim 1, wherein the glycoluril resin comprises from about 15 to about 50 wt % of the overcoat layer.

5. The bias charge roller of claim 1, wherein the overcoat layer has a thickness of from about 1 μm to about 50 μm.

6. The bias charge roller of claim 1, wherein the acrylic resin is derived from an acrylate having the structure of Formula (I): 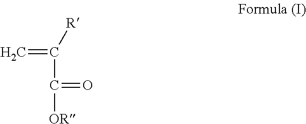
wherein R′ and R″ are independently hydrogen or alkyl.

7. The bias charge roller of claim 1, wherein the glycoluril resin has the structure of Formula (II): 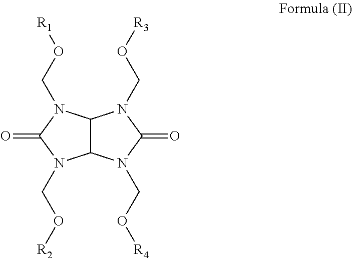
wherein R₁, R₂, R₃, and R₄ are independently H or alkyl having from 1 to about 8 carbon atoms.

8. The bias charge roller of claim 7, wherein R₁, R₂, R₃, and R₄ are butyl.

9. The bias charge roller of claim 1, wherein the overcoat layer further comprises a low surface energy additive.

10. A bias charge roller comprising an overcoat layer, wherein the overcoat layer is formed from a coating solution comprising:
an acrylic resin;
a glycoluril resin; and
a catalyst.

11. The bias charge roller of claim 10, wherein the coating solution and the overcoat layer do not contain conductive particles.

12. The bias charge roller of claim 10, wherein the acrylic resin is derived from an acrylate having the structure of Formula (I): 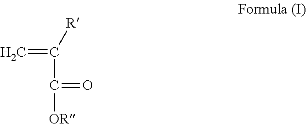
wherein R′ and R″ are independently hydrogen or alkyl.

13. The bias charge roller of claim 10, wherein the glycoluril resin has the structure of Formula (II): 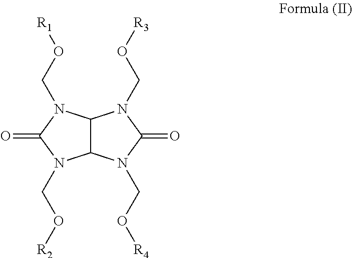
wherein R₁, R₂, R₃, and R₄ are independently H or alkyl having from 1 to about 8 carbon atoms.

14. The bias charge roller of claim 10, where the catalyst is selected from the group consisting of oxalic acid, maleic acid, carboxylic acid, ascorbic acid, malonic acid, succinic acid, tartaric acid, citric acid, p-toluenesulfonic acid, methanesulfonic acid, and mixtures thereof.

15. The bias charge roller of claim 10, wherein the overcoat layer further comprises a low surface energy additive.

16. An image forming apparatus for forming images on a recording medium comprising:
a) an electrophotographic imaging member having a charge-retentive surface to receive an electrostatic latent image thereon;
b) a development component to apply a developer material to the charge-retentive surface and form a developed image on the charge-retentive surface;
c) a transfer component for transferring the developed image from the charge-retentive surface to another member or a copy substrate;
d) a fusing member to fuse the developed image to the copy substrate; and
e) a bias charge roller for applying a charge to the charge-retentive surface, the bias charge roller having an overcoat layer, the overcoat layer comprising an acrylic resin crosslinked with a glycoluril resin.

17. The image forming apparatus of claim 16, wherein the overcoat layer does not contain conductive particles.

18. The image forming apparatus of claim 16, wherein the glycoluril resin has the structure of Formula (II): 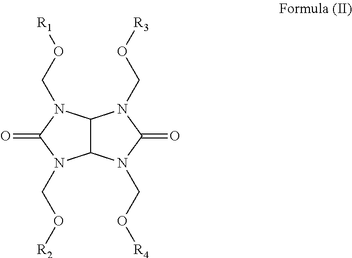
wherein R₁, R₂, R₃, and R₄ are independently H or alkyl having from 1 to about 8 carbon atoms.

19. The image forming apparatus of claim 18, wherein R₁, R₂, R₃, and R₄ are butyl.

20. The image forming apparatus of claim 16, wherein the overcoat layer further comprises a low surface energy additive.
